(19) United States
(12) Patent Application Publication
(10) Pub. No.: US 2011/0148646 A1
(43) Pub. Date: Jun. 23, 2011

(54) DEVICE FOR CONFORMING RECYCLE OF DISPOSABLE MEDICAL HANDPIECE

(75) Inventors: Jeong-Tack KO, Namyangju-si (KR); Eung-Joo LEE, Seongnam-si (KR)

(73) Assignee: ALLOTECH CO., LTD., Namyangju-si (KR)

(21) Appl. No.: 12/784,113

(22) Filed: May 20, 2010

(30) Foreign Application Priority Data
Dec. 21, 2009 (KR) 10-2009-0127741

(51) Int. Cl. G08B 21/00

(52) U.S. Cl. 340/679

(57) ABSTRACT

Disclosed is a device for confirming recycle of a disposable medical handpiece, which can prevent imprudent recycle of the medical handpiece that should be discarded after one time. The device includes a signal conversion unit which receives DC power from the handpiece and detects voltage applied to a driving motor of the handpiece to convert the voltage into a rated signal and output the rated signal; a control unit which receives the output signal of the signal conversion unit, detects an initial operation state of the driving motor based on the output signal and then outputs a lamp switching signal when the driving motor is operated again after a predetermined operation interval is elapsed; and a lamp which is connected with an output terminal of the control unit and turned on in response to the lamp conversion signal.

### BACKGROUND OF THE INVENTION

1. Field of the Invention

The present invention relates to a medical handpiece, and more particularly, to a device for confirming recycle of a disposable medical handpiece, which can recognize the recycle state of the disposable medical handpiece and display the result of the recognition to thereby restrict previously the illegal use of the handpiece.

2. Description of Related Art

In general, surgical handpieces, for example, drills, reamers and saws, are surgical power driven devices commonly used in a surgical operation. Such surgical handpiece generally includes a motor and a housing for housing a complementary control circuit for controlling the operation of the motor.

A structure of the handpiece will be described exemplarily for to a saw, i.e. a sagittal saw: it includes a head extending forwardly from the handpiece. An oscillating shaft is provided in an inside of the head, and a saw blade is removably attached to oscillating shaft. The blade has teeth formed at an exposed front edge thereof. The teeth cut the site where the blade is applied. A driving device in an inside of the housing generates the power.

The applied power operates the oscillating shaft so that the shaft and the blade attached thereto move in a back-and-forth pattern. When the saw is operated as such, the teeth of the blade moves in the back-and-forth pattern with respect to the site where it is applied.

Due to the forward pressure applied by a surgeon who grapes the saw, the teeth cut and separate the firm site where the blade is applied. The sagittal saw is commonly used in a surgical operation process for selective removal of a bone. Here, an exemplary operation may be to resect a bone in a joint and replace it with an artificial joint.

In the surgical operation, when a section is resected from the rest of the bone, it is important to ensure that the section is resected along a correct line. The correctness is essential, and this is because the substitute joint normally has a factor designed so as to be correctly put in the space formed by a cutting line of the cross section of the bone located in place. To ensure that the cutting is properly formed in the bone, a surgeon generally mounts a cutting guide, which is generally called as a jig, on a portion of the bone in the vicinity of the section where the resection is carried out.

In one example, the cutting guide has a block shape having a set of correctly formed slots. These slots form a line and the bone is cut along the line. The surgeon resects the bone by inserting the saw blade successively into the slots. Once the blade is inserted into the slot, the saw operates. This arrangement allows the surgeon resecting the bone along the correctly defined line.

The currently available sagittal saw and its complementary blade cut the bone properly to which the blade is applied. However, such combination has some limitation. A variety of commercially available sagittal saws is provided with an oscillating flat blade. The blade scrubs inevitably the material of the cutting guide that defines the slot(s) into which the blade is inserted. Such repeated contact results in abrasion of the material that forms these slots. Consequently, the slot may be enlarged so as not to form the intended cutting line correctly any more. Once the cutting guide is worn down, the blade is replaced.

And, when the operation is completed, the surgical handpiece is discarded together with the replacement of the blade. This is because there is a possibility that blood of a patient may infiltrate into the handpiece. Therefore, the surgical handpiece is also used as a disposable one to prevent medical malpractice previously. However, there is found some recycle of expensive surgical handpieces and there is therefore a risk of secondary infection of another patient due to operation using the recycled handpiece. That is, the recycle of the handpiece is prohibited under the ethical responsibility of an operator, but the system for monitoring the recycle of the handpiece could not yet be established.

### SUMMARY OF THE INVENTION

Embodiments of the present invention are directed to a device for confirming the recycle of a disposable medical handpiece, which alarms the recycle state of the disposable medical handpiece to prevent infection of another patient by a mistake of an operator previously.

Also, embodiments of the present invention are directed to a device for confirming the recycle of a disposable medical handpiece, which can prevent the risk of the imprudent recycle in the process of collecting the disposable handpiece by the function of alarming the recycle state of the handpiece to thereby be able to raise stability and reliability of a medical industry.

In one embodiment, a device for conforming the recycle of a disposable medical handpiece includes a signal conversion unit which receives DC power from the handpiece and detects voltage applied to a driving motor of the handpiece to convert the voltage into a rated signal and output the rated signal; a control unit which receives the output signal of the signal conversion unit, detects an initial operation state of the driving motor based on the output signal and then outputs a lamp switching signal when the driving motor is operated again after a predetermined operation interval (Δt) is elapsed; and a lamp (L) which is connected with an output terminal of the control unit and turned on in response to the lamp conversion signal, and is provided in an inside of the handpiece.

Preferably, the lamp (L) is a light emitting diode, and light emitting diode is lit in a green color when the driving motor is initially operated and is lit in a red color when the driving motor is operated again after the predetermined operation interval (Δt) is elapsed.

The device for confirming recycle of a disposable medical handpiece in accordance with the present invention can prevent imprudent recycle of the medical handpiece that should be discarded after one time use and thus prevent a secondary infection of another patient. Also, by excluding an environmental factor that the handpiece is recyclable by mistake of an operator, it is possible not only to prevent a medical malpractice but also raise reliability of the disposable medical handpiece on the basis of the recycle restriction function.

### BRIEF DESCRIPTION OF THE DRAWINGS

FIG. 1 illustrates a disposable medical handpiece in accordance with a first embodiment of the present invention.

FIG. 2 illustrates a submersion sticker of FIG. 1.

FIG. 3 illustrates a disposable medical handpiece in accordance with a second embodiment of the present invention.

FIG. 4 is a time chart for illustrating operation of FIG. 3.

FIG. 5 is a drawing illustrating the disposable medical handpiece of FIG. 3 according to its operation states.

### DESCRIPTION OF SPECIFIC EMBODIMENTS

Hereinafter, preferred embodiments of the present invention will be described in detail with reference to accompanying drawings.

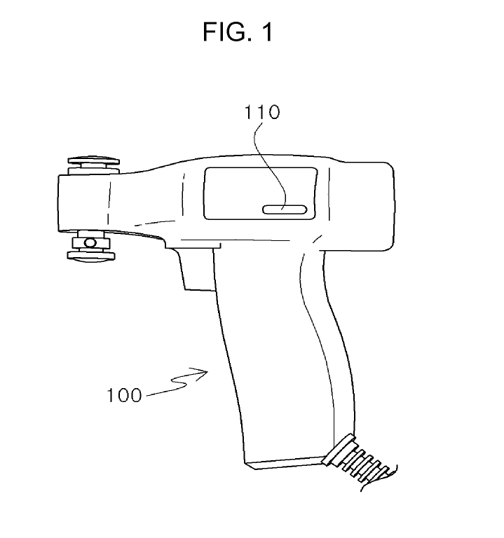

First, FIG. 1 illustrates a disposable medical handpiece in accordance with a first embodiment of the present invention. As shown, an upper portion of a medical handpiece 100 is attached at an upper end thereof with a submersion sticker 110 for detecting whether the handpiece 100 has been in contact with water. The submersion sticker 110 is of a chemical material of which original color is changed when it comes in contact with water, and detects whether the medical handpiece 100 has been washed for recycle.

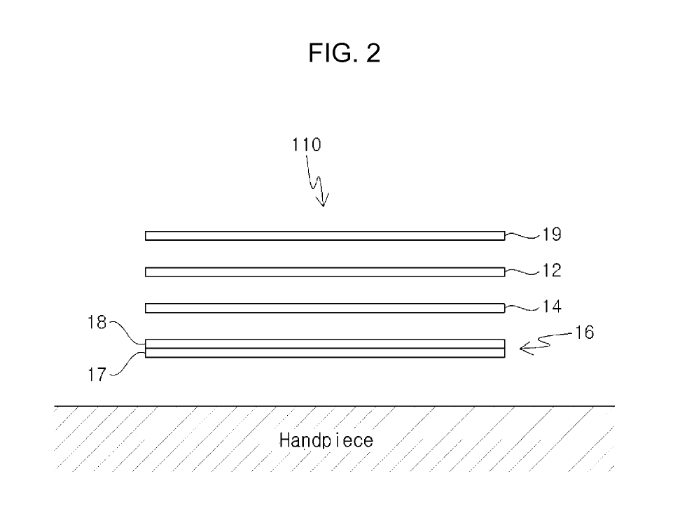

The submersion sticker 110 is preferably fabricated and stuck by a known technique, and it is stuck, as shown in FIG. 2, onto the handpiece 100 with being attached to a release liner. The release liner may include, for example, both a paper liner such as a glassine paper and a craft paper and a film liner, but not particularly limited thereto. When using the paper liner, an anti-moisture layer may be added to prevent unexpected spread of water soluble ink printed on an adhesive face of the liner.

The submersion sticker 110 is normally provided with a printing paper 12, which is normally called as a face stock. The printing paper 12 may employ all water absorbable materials including papers such as vellum paper, art paper, mummy paper, roll paper and tissue paper, and nonwoven fabric which can absorb water, and preferably thin papers which have a large content of pulp and are not coated at all or nonwoven fabric having an excellent water absorptivity, and most preferably tissue paper.

An inside face of the printing paper 12, i.e. the face to be attached to the release liner 20 and the handpiece 100 is formed with a printed layer 14, and the printed layer 14 is printed with water soluble ink that is spreadable by water. The water soluble ink printed on the printed layer 14 spreads by water penetrated through the printing paper 12 during the washing process for recycle of the handpiece 100, and it is preferred that the water soluble ink has high water solubility. It is also preferred that the water soluble ink reacts well with water to spread quickly and is easy to confirm its spread with naked eye.

Further, the water soluble ink is preferably printed with a lattice pattern having a vivid color that can be easily distinguished from a bright colored ground so that its deformation by the spread can be easily recognized. At this time, the vivid color used in the pattern is preferably red colors, and crimson red or bright pink is particularly preferred to distinguish the pattern. Furthermore, this lattice pattern can be very easily distinguished when red colored X like patterns are continuously arranged on a bright colored ground such as white ground. An adhesive layer 16 for adhering the sticker onto a surface of another object is formed on the printed layer 14.

The adhesive layer 16 may be formed by simply applying adhesive on the printed layer 14, and preferably may employ a double sided tape of which both sides are applied with adhesive. The double sided tape functions not only to adhere the printed paper to another object but also to protect the water soluble ink printed on the printed layer 14 since the double sided tape itself is made of a film material. At this time, an inner sheet 17 of the double sided tape may employ Washi paper, films, etc., and it is most preferable to employ films having excellent transparency.

Further, an adhesive 18 used on the adhesive layer 16 may employ all adhesives including water soluble, rubber based, silicon based and acryl based adhesives, and most preferably an acryl adhesive that can adhere with a low pressure at room temperature, has excellent heat resistance, solvent resistance and weatherability and has colorless and transparent properties. It is also most preferable to employ the acryl adhesive having excellent adhesiveness with plastic or metal on a face which is attached to the handpiece 100.

In the disposable medical handpiece 100 in accordance with the present invention as described above, its color is changed during the washing process for recycle after one time use of the handpiece and the changed color is sufficiently distinguished to alarm an operator that the handpiece should not be recycled.

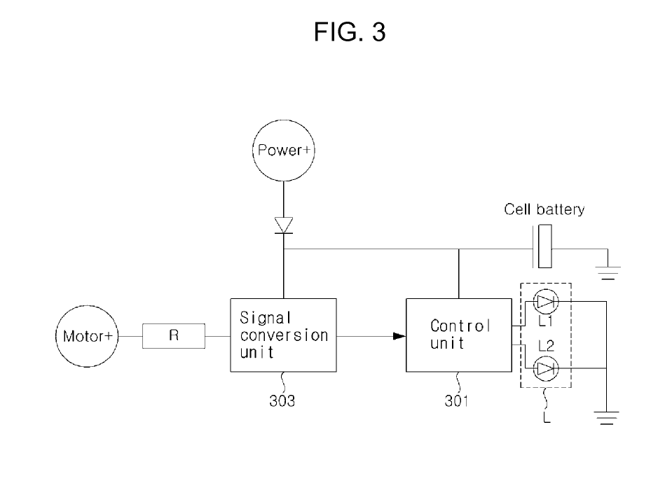

Meanwhile, in addition to the aforementioned submersion sticker 110, the present invention displays the recycle state of the disposable medical handpiece 100 by a predetermined lighting device. This is to alarm the recycle through a light source when the handpiece is recycled after a predetermined interval, and the recycle confirmation device configured as shown in FIG. 3 is mounted in an inside of the handpiece 100.

As shown, the recycle confirmation device includes a signal conversion unit 303 which receives DC power from the handpiece 100 and detects the voltage applied to a driving motor of the handpiece 100 to convert the voltage into a rated signal and output the rated signal; a control unit 301 which receives the output signal of the signal conversion unit 303, detects an initial operation state of the driving motor based on the output signal and then outputs a lamp switching signal when the driving motor is operated again after a predetermined operation interval (Δt) is elapsed; and a lamp L which is connected with an output terminal of the control unit 301 and turned on in response to the lamp conversion signal.

Herein, the control unit 301 has an internal counter and the decision for the interval is carried out by the internal counter. To this end, the control unit 301 is connected with a cell battery and the internal counter of the control unit 301 is therefore continuously operated even though the power supply to the handpiece 100 is interrupted.

Meanwhile, the signal conversion unit 303 is for detecting the operation state of the driving motor that drives the handpiece 100, and may employ an analogue/digital (A/D) converter that converts the operating voltage of the driving motor into a digital signal and may employ a constant voltage output device, if necessary. The constant voltage output device may be a zener diode or a regulator. When the signal conversion unit 303 employs a zener diode or a regulator, the control unit 301 decides the output signal of the constant voltage output device as a switching signal.

Also, the lamp L is preferably a light emitting diode (LED), and more preferably, the lamp L is lit in a green color when the driving motor is operated for the first time and is lit in a red color when the driving motor is operated again after the aforementioned interval. Therefore, the LED may employ two LEDs of green color and red color, but it is also possible to change the color by the control unit 301 using one color diode.

The signal conversion unit 303 and the control unit 301 are connected with a power terminal for power supply to the handpiece 100, and the power is thus supplied to the signal conversion unit 303 and the control unit 301 when the rated power is supplied to the handpiece 100. Further, the control unit 301 has an internal flash memory to store previous switching signal of the lamp L. The control unit 301 may employ a 4-bit MICOM provided with an internal counter, and if necessary, may employ a 8-bit MICOM provided with an internal counter and an A/D converter.

Hereinafter, operation of the present invention will be described in detail with reference to accompanying drawings.

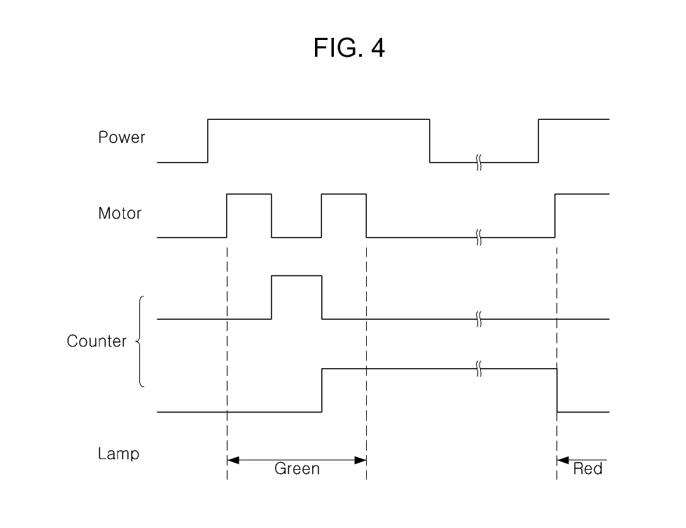

FIG. 4 is a time chart for illustrating the operation of the handpiece in accordance with the present invention. First, an operator connects the handpiece 100 to a controller (not shown, a device for supplying a rated power to the handpiece) prior to the use of the handpiece 100, and operates a power switch of the controller. Then, the power is supplied to the signal conversion unit 303 and the control unit 301. Upon the power supply, a conversion to a rated voltage of the signal conversion unit 303 and the control unit 301 is carried out, and to this end, a separate constant voltage regulator may be used.

When the rated power is applied to the control unit 301, the control unit 301 reads out information of current state stored in the internal memory (flash memory). The state information is for deciding whether the handpiece 100 is used for the first time, and the control unit 301 determines whether an initial value set upon shipment of the product is maintained.

That is, as shown in FIG. 4, when the rated power is applied to the control unit 301, the control unit 301 turns the green color of the lamp L on based on the previously stored initial value flag. The turning-on of the green color means that it is the first time to use the handpiece, and the operator can therefore use the handpiece safely. However, the number of the use of the handpiece 100 is not simply limited to one time, and when the handpiece is used various times to the same patient in the operation process, the control unit 301 recognizes this state and turns continuously the green lamp on.

Meanwhile, after the power is supplied to the handpiece 100, the signal conversion unit 303 recognizes the operation state of the driving motor of the handpiece when the handpiece is driven by the operator. The signal conversion unit 303 may employ an A/D converter or may employ a zener diode or a photocoupler, and this signal conversion unit 303 recognizes the operation state of the driving motor of the handpiece as an electric signal. For example, when the signal conversion unit 303 is an A/D converter, it converts the voltage applied to the driving motor into a digitized signal and recognized that the driving motor is currently operated when the digitized signal is a predetermined level, i.e. a signal corresponding to an operation voltage of the driving motor.

Also, when the signal conversion unit 303 is a zener diode, it recognizes difference between the voltage applied to the driving motor and an internal voltage of the zener diode and notifies the difference to the control unit 301, thereby recognizing an operation time point of the driving motor. Also, when the signal conversion unit 303 is a photocoupler, it recognizes the operation state of the driving motor by a resistor connected in parallel with the driving motor and a light emitting part of the photocoupler and sends a signal received by a receiving part of the photocoupler to the control unit 301.

As such, the signal conversion unit 303 monitors beginning and ending of the operation of the driving motor mounted in the handpiece 100 and notifies the monitoring result to the control unit 301. The control unit recognizes the beginning and ending of the operation of the handpiece as shown in FIG. 4 based on the output signal of the signal conversion unit 303, and at the same time, carries out count by deciding a time point of the operation of the driving motor and a time point of the re-operation.

The control unit 301 includes a counter therein like a conventional MICOM, and recognized a difference between the time where the operation of the driving motor is ended and the time where the driving motor is operated again, i.e. operation interval T of the driving motor, based on a control algorithm. Herein, the operation interval T is the count result of the control unit 301 and the control unit 301 compares the operation interval T with the predetermined operation interval Δt to decide whether the operation interval T is less than the predetermined operation interval Δt.

Herein, the predetermined operation interval Δt may be set on the basis of operator's experience, and is set to 30 to 60 minutes, preferably 50 minutes in an embodiment of the present invention. Therefore, the control unit 301 decides that the handpiece is not in a recycled state when the driving motor of the handpiece is operated again within the time less than the predetermined operation interval Δt (50 minutes) after the driving motor is initially operated. That is, the flag of the previous state information stored in the flash memory of the control unit 301 is not changed.

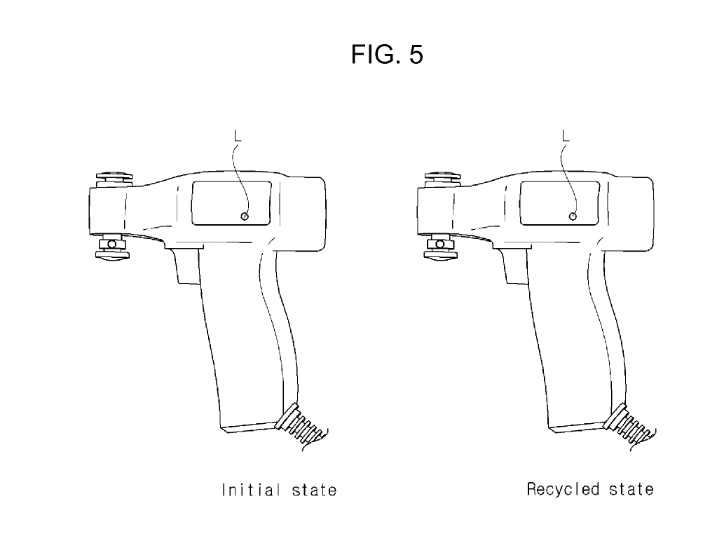

Consequently, the lamp L maintains the green color as shown in FIG. 5 though the handpiece is used many times with the time less than the predetermined operation interval Δt. Meanwhile, though the driving of the handpiece 100 is ended after the completion of the operation, the internal counter of the control unit continues the count. And, when the handpiece once used is used again later, the control unit 301 decides whether the predetermined operation interval Δt has been elapsed after the operation time of the driving motor detected last.

As the result of decision, the control unit 301 maintains the color of the lamp L green if the predetermined operation interval Δt has not been elapsed. On the contrary, if the predetermined operation interval Δt has been elapsed, the control unit 301 changes the color of the lamp L to red to thereby remind that the recycle is not allowed. The Lamp L may be flicked by the control unit 301 to raise the aforementioned effect.

As described above, the present invention is a recycle confirmation device for restricting the recycle of a handpiece and can prevent a medical malpractice previously by visually notifying the recycle of the handpiece due to mistake of an operator.

Meanwhile, although it is notified using the lamp L that the recycle of the handpiece is not allowed, a switching circuit that forcibly interrupts the power supplied to the driving motor when the color of the lamp L is red may be further included. The switching circuit may employ a relay, a high power transistor or a SCR device.

Also, the device for confirming the recycle of the handpiece in accordance with the present invention may generates alarm sound using a buzzer or a piezoelectric speaker if necessary, although it changes the color of the lamp L. That is, at the time point where the handpiece is used again, the control unit generates the alarm sound through the buzzer or piezoelectric speaker to alarm the recycle state of the handpiece to an operator prior to the operation. If the buzzer is used, the control unit 301 is provided with a driver (transistor) for driving the buzzer and drives the buzzer through the driver when the power for the operation is supplied to the handpiece.

If the piezoelectric speaker is used, the control unit 301 supplies a pulse signal of a predetermined frequency band using a non-contacting switching device such as a transistor and uses the power for handpiece as the power supplied to the transistor. This is for driving the piezoelectric speaker when the power is supplied to the handpiece. Therefore, a predetermined alarm sound is generated when the operator recycles the handpiece during the operation process.

As described above, as the device for confirming a disposable medical handpiece in accordance with the present invention displays the recycle state of the disposable handpiece by spending some space of the handpiece, it alarms and restricts the recycle due to the imprudent recycle of the handpiece or mistake of an operator to thereby prevent infection of a patient or medical malpractice Therefore, it is possible to raise the reliability of a medical industry and restrict unnecessary spending of medical insurance related companies and it is thus considered that industrial worth is sufficiently high.

While the present invention has been described with respect to the specific embodiments, it will be apparent to those skilled in the art that various changes and modifications may be made without departing from the spirit and scope of the invention as defined in the following claims.

What is claimed is:

1. A device for conforming recycle of a disposable medical handpiece, which alarms recycle state of a disposable medical handpiece (100), wherein the device comprises: a signal conversion unit (303) which receives DC power from the handpiece and detects voltage applied to a driving motor of the handpiece (100) to convert the voltage into a rated signal and output the rated signal; a control unit (301) which receives the output signal of the signal conversion unit (303), detects an initial operation state of the driving motor based on the output signal and then outputs a lamp conversion signal when the driving motor is operated again after a predetermined operation interval (Δt) is elapsed; and a lamp (L) which is connected with an output terminal of the control unit (301) and turned on in response to the lamp switching signal, and is provided in an inside of the handpiece (100).

2. The device of claim 1, wherein the control unit (301) has an internal counter and carries out decision for the interval by the internal counter based on a cell battery that stores a predetermined electric capacity.

3. The device of claim 1, the signal conversion unit (303) is any one of an analogue/digital (A/D) converter that converts the operating voltage of the driving motor into a digital signal, and a zener diode or a regulator for recognizing the operation voltage of the driving motor as a set constant voltage.

4. The device of claim 1, wherein the lamp (L) is a light emitting diode (LED), and the LED is lit in a green color when the driving motor is initially operated and is lit in a red color when the driving motor is operated again after the predetermined operation interval (Δt) is elapsed.

5. The device of claims 1, wherein the handpiece (100) is attached at an upper end thereof with a submersion sticker (110) for detecting whether the handpiece (100) has been in contact with water.

6. The device of claims 1, wherein the handpiece (100) further includes a sound output unit that outputs a predetermined sound in response to the lamp switching signal.

7. The device of claim 6, wherein the sound output unit is a buzzer or a piezoelectric speaker.
